(19) United States
(12) Patent Application Publication
(10) Pub. No.: US 2018/0285248 A1
(43) Pub. Date: Oct. 4, 2018

(54) SYSTEM AND METHOD FOR GENERATING TEST SCRIPTS FOR OPERATIONAL PROCESS TESTING

(71) Applicant: WIPRO LIMITED, BANGALORE (IN)

(72) Inventor: Munish Kumar Gupta, Bangalore (IN)

(73) Assignee: Wipro Limited

(21) Appl. No.: 15/475,592

(22) Filed: Mar. 31, 2017

(51) Int. Cl. G06F 11/36; G06N 3/02

(52) U.S. Cl. CPC G06F 11/3684; G06N 3/02

(57) ABSTRACT

Embodiments of present disclosure disclose efficient system and method for identifying operational process associated with UI of enterprise based on inputs from user and automatic generating one or more test scripts for testing of operational process. System discloses to directly capture inputs from UI by configuring URL of UI to system. Method includes capturing at least one of, one or more elements, one or more labels associated with each of one or more elements, from UI and one or more error conditions associated with one or more elements. Upon capturing, one or more attributes are identified from plurality of attributes based on mapping of one or more labels with plurality of attributes and further operational process is identified from plurality of operational processes based on one or more attributes. One or more test scripts are generated for identified operational process based on metadata associated with operational process.

### TECHNICAL FIELD

The present subject matter is related in general to the field of testing of operational processes, more particularly, but not exclusively to a system and method for generating test scripts for operational process testing.

### BACKGROUND

Testing, also referred as software testing, is a process of executing a program, an application or a product with intent of finding software bugs. Testing in an enterprise may include testing of User Interface (UI), also referred Graphical UI (GUI) associated with the enterprise. Further, testing of the UI includes testing of operational processes associated with the UI. The testing may be stated as process to validate and verify whether the operational processes meet business and technical requirements. The testing may also be used to test features and functionality of the operational processes and may cover all the scenarios including failure paths and boundary cases associated with the operational processes. In recent times, automation testing is evolved where a tester writes test scripts also referred as test cases which include a set of instructions. The test scripts may be used for operational processes testing. Each of the operational processes may be mapped with one or more corresponding test scripts and it is essential to execute the test scripts associated with the each of the operational processes for testing the operational processes.

There are conventional systems for automated generation of the test scripts. In these conventional systems, the generation of the test scripts require access to data from backend system of the UI. In scenarios where there is modification or updating of the UI, change in the operational processes may arise and there may be need for varying the corresponding test scripts for the testing. Since there are separate set of test scripts for each of the operational processes, upgradation in the UT may result in generation of redundant functional test scripts. Also, there may be a need for the tester to redefine entire set of the test scripts as the system for generating the test scripts may not identify change in attributes and their functionality associated with the operational processes.

One of the conventional systems discloses generation of the test scripts by test agents where test agents monitor backend interface that interfaces an application with a backend system of an enterprise. The test scripts may be generated based on the monitoring. However, in some scenarios, the test agents may not have access to the backend enterprise system for identifying the changes in the UI. In such scenarios, it may not be possible to reuse already generated test scripts for testing and there may be need for rebuilding of entire test scripts for the testing. Some of the existing systems disclose tools to write the test scripts which may be adapted for every change in the operational processes. However, complexity in the tools does not guarantee desired outcome of testing using same test scripts for varying UIs with same operational process without access to the backend system of the user interface.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for generating test scripts for operational process testing. The method includes capturing at least one of one or more elements, one or more labels associated with each of the one or more elements, from a user interface and one or more error conditions associated with the one or more elements. Upon capturing, one or more attributes are identified from a plurality of attributes based on mapping of the one or more labels with the plurality of attributes and further an operational process is identified from a plurality of operational processes based on the one or more attributes. One or more test scripts are generated for the identified operational process based on metadata associated with the operational process.

In an embodiment, the present disclosure relates to a test script generation system comprising a processor and a memory communicatively coupled to the processor. The memory stores processor-executable instructions, which, on execution, cause the processor to generate one or more test scripts. Initially, the test script generation system captures at least one of, one or more elements, one or more labels associated with each of the one or more elements, from a user interface and one or more error conditions associated with the one or more elements. Upon capturing, one or more attributes are identified from a plurality of attributes based on mapping of the one or more labels with the plurality of attributes and further an operational process is identified from a plurality of operational processes based on the one or more attributes. One or more test scripts are generated for the identified operational process based on metadata associated with the operational process.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an exemplary environment for generating test scripts for operational process testing in accordance with some embodiments of the present disclosure;

FIG. 2 shows a detailed block diagram of test script generation system for generating test scripts for operational process testing in accordance with some embodiments of the present disclosure;

FIG. 3 illustrates a flowchart showing a method for generating test scripts for operational process testing in accordance with some embodiments of present disclosure;

FIG. 4 illustrates a flowchart showing a method for identifying operational process to generate test scripts for operational process testing in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to efficient system and method for identifying an operational process associated with a UI of an enterprise based on inputs from a user and automatically generating one or more test scripts for testing of the operational process. The system discloses to directly capture the inputs from the UT by configuring Uniform Resource Locator (URL) of the UI to the system. The method for generating the one or more tests scripts includes capturing at least one of, one or more elements, one or more labels associated with each of the one or more elements, from a user interface and one or more error conditions associated with the one or more elements. Further, one or more attributes from a plurality of attributes may be identified based on mapping of the one or more labels with the plurality of attributes and the operational process from a plurality of operational processes is identified based on the one or more attributes. The one or more test scripts is generated for the identified operational process based on metadata associated with the operational process.

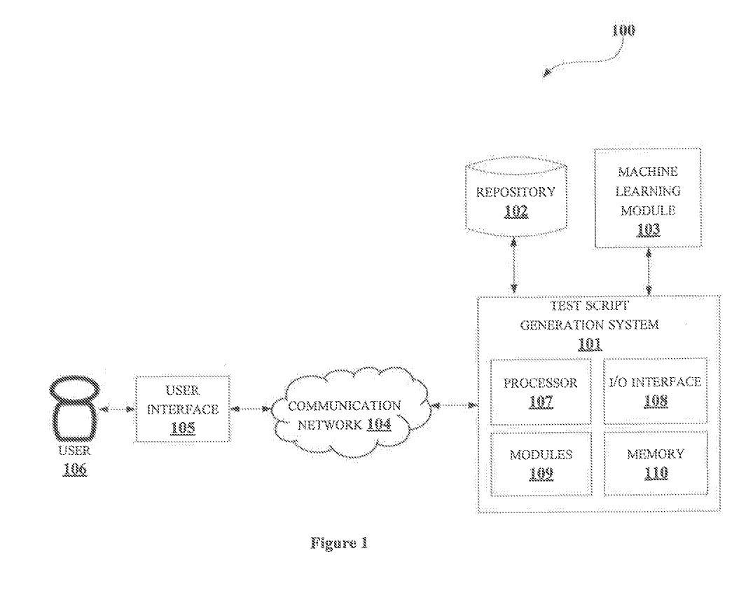

FIG. 1 illustrates an exemplary environment for generating test scripts for operational process testing in accordance with some embodiments of the present disclosure. As shown in FIG. 1, the environment 100 may include a test script generation system 101, a repository 102, a machine learning module 103, a communication network 104 and a UI 105 associated with a user 106.

The user 106 may be one of a tester, an admin, a stakeholder, a vendor, a customer and any person associated with an enterprise whose related UI may be tested. The UI 105 may be any UI which is designed to provision the user 105 to interact with an application associated with the enterprise. In an embodiment, the UI 105 may be one of a webform and Hyper Text Markup Language (HTML) form through which the user 105 may provide the data. The repository 102 may be a database configured to store data associated with the enterprise and communicable with the test script generation system 101. In an embodiment, the repository 102 may communicate with the test script generation system 101 via a communication network (not shown in figure). In an embodiment, the repository 102 may also be referred to as a metadata repository. In an embodiment, the repository 102 may be integrated within the test script generation system 101. The data associated with the enterprise, which may also be referred to a metadata, may include, but are not limited to, enterprise data, business domain data, operational process data, attributes data, validation data associated with the plurality of attributes, condition data associated with the plurality of validation data and unit level test scripts. In an embodiment, the data may be provided by the user 106 associated with the enterprise. In an embodiment, the repository 102 may be updated with the metadata during updating of the test script generation system 101.

The test script generation system 101 further includes a processor 107, I/O interface 108, one or more modules 109 and a memory 110. In some embodiment, the memory 110 may be communicatively coupled to the processor 107. The memory 110 stores processor executable instructions, which, on execution, may cause the test script generation system 101 configured to generate the one or more test scripts for the operational process testing. The test script generation system 101 may be implemented in a variety of computing systems, such as a laptop computer, a desktop computer, a Personal Computer (PC), a notebook, a smartphone, a tablet, e-book readers (e.g., Kindles and Nooks), a server, a network server, and the like.

Initially, at least one of, one or more elements, one or more labels associated with each of the one or more elements, from the UI 106 and one or more error conditions associated with the one or more elements may be captured by the test script generation system 101. The test script generation system 101 may capture via the communication network 104. In an embodiment, the communication network 104 may include, without limitation, a direct interconnection, Local Area Network (LAN), Wide Area Network (WAN), wireless network (e.g., using Wireless Application Protocol), the Internet, etc. The one or more elements and the one or more labels may be inputs provided by the user 106 via the UI 105. In an embodiment, the one or more error conditions may be recorded by the test script generation system 101 based on the one or more elements provided by the user 106. In an embodiment, the one or more error conditions may arise when there exists error with respect to the inputs provided by the user 106. In an embodiment, the error conditions may arise when the inputs may not be provided by the user 106 via the UI 105.

Upon capturing, the test script generation system 101 identifies one or more attributes from a plurality of attributes based on mapping of the one or more labels with the plurality of attributes. In an embodiment, the plurality of attributes may be the attribute data in the repository 102. In an embodiment, the plurality of attributes may relate to parameters associated with each of the plurality of operational processes. In an embodiment, the plurality of attributes may include, but are not limited to, objectives, policies, inputs, outputs, nature and the like associated with each of the plurality of operational processes. The mapping of the one or more labels with the plurality of attributes includes recognizing identical one or more attributes from the plurality of attributes by matching the one or more labels with the plurality of attributes associated with the repository 102. In an embodiment, when the identical one or more attributes are not recognized, synonyms of the one or more labels may be mapped with the plurality of attributes to identify the one or more attributes.

Upon identifying the one or more attributes, the operational process from a plurality of operational processes is identified based on the one or more attributes. In an embodiment, the plurality of operational processes may be stored in the repository 102 as the operational data. In an embodiment, each of the plurality of operational processes is associated with plurality of attributes. For identifying the one or more operational processes, initially, the one or more attributes may be compared with the plurality of attributes of each of the plurality of operational processes. In an embodiment, comparing may include comparing each of the one or more attributes with the plurality of attributes of each of the plurality of operational processes. Based on the comparison, a score for each of the plurality of operational processes may be calculated. The score of each of the plurality of the operational processes may also be referred as hit percentage of the corresponding operational process. In an embodiment, the score provides similarity rate between the one or more attributes and the plurality of attributes of each of the plurality of operational processes. Further, based on at least one of the score and a predefined score threshold value, the operational process may be identified. In an embodiment, the score of each of the plurality of operational processes may be compared with the predefined score threshold value. The operational process from the plurality of operational processes for which the score may be greater than the predefined score threshold value may be identified for generating the one or more test scripts. In an embodiment, when two or more operational processes from the plurality of operational processes may be associated with the score greater than predefined score threshold value, then operational processes from said two or more operational process may be identified based on highest value of the score. When the score of plurality of the operational processes is lesser than predefined the predefined score threshold value, one or more new operational processes along with associated metadata may be obtained from the user 106 for generating the one or more test scripts.

Upon identifying the operational process, the one or more test scripts may be generated for the operational process based on the metadata associated with the operational process. In an embodiment, the metadata may be stored and retrieved from the repository 102. In an embodiment, one or more techniques, known to a person skilled in art, may be implemented for generating the one or more test scripts for the operational process.

The method of the present disclosure further includes updating at least one of one or more new attributes, one or more new operational processes and the metadata, when one of the one or more attributes and the operational process may not be identified. When the one or more labels may not be mapped with the plurality of attributes, the one or more new attributes, associated with the one or more labels, are updated using the machine learning module 103. In an embodiment, the updating may be based on based on plurality of patterns associated with the plurality of operational processes and corresponding plurality of attributes. In an embodiment, the machine learning module 103 may be configured to learn the plurality of patterns based on at least one of metadata in the repository 102 and inputs from the user 106. In an embodiment, at least one of the one or more new attributes and the one or more new operational processes may be updated manually by the user 106. In an embodiment, the updating of the one or more new operational processes may include, updating one or more attributes, validation rules and other data associated with the one or more new operational processes. In an embodiment, the machine learning module 103 may communicate with the test script generation system 101 via a communication network (not shown in figure). In an embodiment, machine learning module 103 may be integrated within the test script generation system 101.

In an embodiment, the test script generation system 101 receives data from at least one of the UI 105, the machine learning module 103, the repository 102 and other associated data for generating test scripts (not shown in figure) through the I/O interface 108 of the test script generation system 101. Also, the test script generation system 101 transmits data via the I/O interface 108. In one embodiment, the data may be transmitted to at least one of the UI 105, the machine learning module 103, the repository 102 and any other peripheral device (not shown in Figure) associated with the test script generation system 101. Further, the I/O interface 107 may be coupled with the processor 106 of the test script generation system 101.

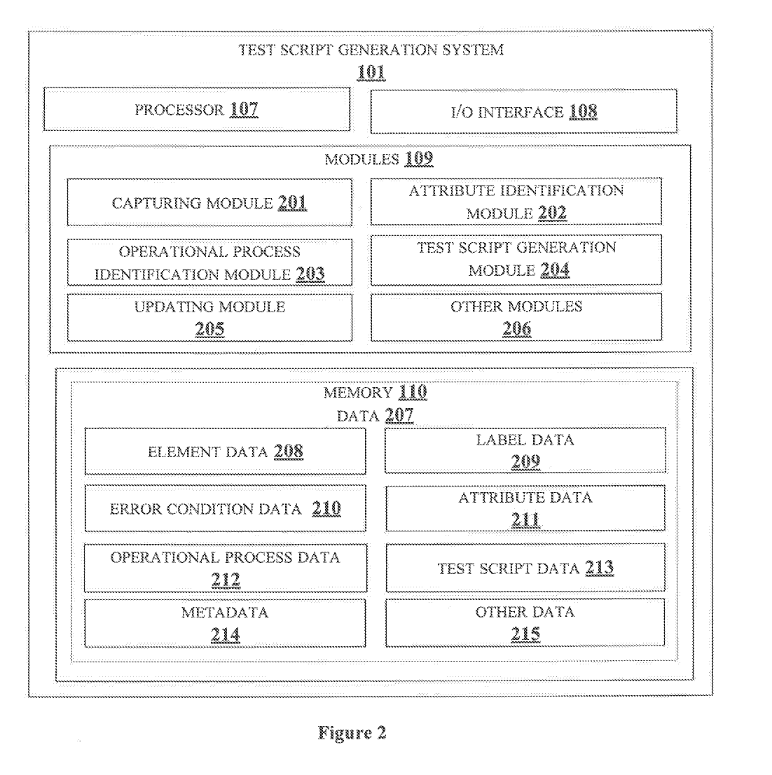

FIG. 2 shows a detailed block diagram of the test script generation system 101 for generating test scripts for the operational process testing in accordance with some embodiments of the present disclosure. Data 207 in the memory 110 and the one or more modules 109 of the test script generation system 101 may be described herein in detail.

In one implementation, the one or more modules 109 may include, but are not limited to, a capturing module 201, an attribute identification module 202, an operational process identification module 203, a test script generation module 204, an updating module 205 and one or more other modules 206 associated with the test script generation system 101.

In an embodiment, data 207 in the memory 110 may include element data 208 (also referred as the one or more elements 208), label data 209 (also referred as the one or more labels 209), error condition data 210 (also referred as the one or more error conditions 210), attribute data 211 (also referred as the one or more attributes 211), operational process data 212 (also referred as the operational process 212), test script data 213 (also referred as the one or more test scripts 213), the metadata 214, and other data 215 associated with the test script generation system 101.

In an embodiment, the data 207 in the memory 110 may be processed by the one or more modules 109 of the test script generation system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules when configured with the functionality defined in the present disclosure will result in a novel hardware.

The test script generation system 101, for generating the one or more test scripts 213 for testing of the operational process 212, may be associated with the UI 105, the repository 102 and the machine learning module 103 as shown in FIG. 1. Initially, the user 106, who may be person skilled in the art, may build the repository 102 for the testing. In an embodiment, building of the repository 102 may include storing the metadata 214 in the repository 102. The metadata 214, may include, but are not limited to, the enterprise data, the business domain data, the operational process data, the attributes data, the validation data associated with the plurality of attributes, the condition data associated with the plurality of validation data and the unit level test scripts. In an embodiment, the enterprise data may include information associated with the enterprise whose UI may be tested. In an embodiment, the business domain data relates to information regarding business associated with the enterprise. In an embodiment, the operational process data relates to plurality of operational processes associated with the enterprise. In an embodiment, the attributes data relates to the plurality of attributes that may be mapped with each of the plurality of operational processes and data mapped with each of the plurality of attributes for validation. In an embodiment, the validation data relates to one or more validations (also referred to as one or more validation rules) associated with each of the plurality of attributes of each of the plurality of operational processes. The one or more validations may be mapped to one of positive result and negative result associated with the each of the plurality of attributes. In an embodiment, the condition data relates to one or more conditions associated with each of the one or more validations. In an embodiment, the one or more conditions may include boundary conditions and conditions for validating the one of negative result and the positive result. In an embodiment, the unit level test scripts may include one or more test scripts mapped for each of the one or more validations. The unit level test scripts may be associated with testing at unit level of the operational process 212. In an embodiment, the unit level test scripts may be programmed in one or more languages, known to a person skilled in art, and may be configured to the test script generation system 101 for generating one or more test scripts 213 for the operational process 212. In an embodiment, any update and changes associated with the metadata 214 may be considered as feedback by the repository and mappings and relationships associated with the metadata 214 may be updated in the repository. In an embodiment, the updating may be performed using one or more modules, known to a person skilled in art. In an embodiment, the repository 102 may be configured to perform learning and updating, without need for an external module, on a continuous basis.

Consider an example of an enterprise which may be an insurance provider. For testing an UI associated with the insurance provider, the repository 102 may be stored with the metadata 214 associated with the insurance provider. The enterprise data includes data associated with the insurance provider and the business domain data include information relating to business domain associated with the insurance provider. The plurality of operational processes includes services, policies and the like associated with the insurance provider.

In real-time for testing one of the plurality of operational processes associated with the enterprise, the capturing module 201 of the test script generation system 101 captures the one or more elements 208, the one or more labels 209 associated with each of the one or more elements 208, from the UI 105 of the enterprise. In an embodiment, the test script generation system 101 may capture the one or more error conditions 210 associated with the one or more elements 208. For example, consider the UI 106 associated with the insurance provider may be tested using the test script generation system 101. Consider, the testing may be for testing quote and bind functionality of the insurance provider. The UI 105 may be an application form provided to the user 106 to receive data inputs relating to the quote and the bind functionality. In an embodiment, the one or more elements 208 may be text inputted by the user 106 to queries asked in the application form. For example, the one or more elements may include, but are not limited to, car information, driver information, car history information and the like. Each of the one or more labels 209 may be tags associated with each of the one or more elements 208. The one or more labels 209 may be used to indicate the corresponding one or more elements 208. For example, in an embodiment, one or more labels associated with the car information may include, but not limited to, manufacture year of the car, model of the car. Vehicle Identification Number (VIN) of the car and the like. In an embodiment, one or more labels associated with the driver information may include, but not limited to, name of the driver, address of the drive, primary driver information, secondary driver information and the like. In an embodiment, one or more labels associated with the car history information may include, but not limited to, accident information, previous owner information, and the like. In an embodiment, the one or more labels 209 may be inputted by the user 106 via checkboxes and radio buttons in the application form. For example, additional add-on which may include, but not limited to, secondary driver information, additional insurance information, criminal activity information. Driving Under Influence (DUI) records and the like may be inputted by the user 106 through the checkboxes and the radio buttons. In an embodiment, the one or more error conditions 210 may arise when the one or more elements 208 are not provided by the user 106 via the UI 105. In an embodiment, the one or more error conditions 210 may arise when the one or more elements 208 may be incorrect or not as per requirement of the application form. For example, the one or more error conditions 210 may be displayed on the UI 105 as at least one of “Field name is mandatory and need to be filled”, “Date of birth is required”, “Date of claim is less than today's date” and the like. In an embodiment, capturing of the one or more elements 208 and the one or more labels 209, by the test script generation system 101, may be performed using a module, known to a person skilled in art. Said module may be configured to follow actions and inputs of the user 106 and capture the one or more elements 208. In an embodiment, the test script generation system 101 may capture the one or more elements 208 and the one or more labels 209 at HTML form level.

Upon capturing, the attribute identification module 202 of the test script generation system 101 identifies the one or more attributes 211 from the plurality of attributes based on mapping of the one or more labels 209 with the plurality of attributes in the repository 102. The mapping may be performed using one or more mapping tools known to a person skilled in art. The mapping of the one or more labels 209 with the plurality of attributes includes recognizing identical one or more attributes 211 from the plurality of attributes by matching the one or more labels 209 with the plurality of attributes. In an embodiment, when the identical one or more attributes 211 are not recognized, synonyms of the one or more labels 209 may be mapped with the plurality of attributes to identify the one or more attributes 211. For example, when the one or more labels may be address, the one or more attributes 211 may be identified using the synonyms which include, but are not limited to, residence, home, location, zip code, street, house, box number and the like. In an embodiment, the test script generation system 101 uses Natural Language Processing (NLP) to decipher the one or more labels 209 and to identify the synonyms of the one or more labels 209 for the mapping. By capturing the one or more attributes 211, the test script generation system 101 filters the one or more attributes 211, which may be relevant to the operational process 212, from the plurality of attributes.

Upon identifying the one or more attributes 211, the operational process 212 from the plurality of operational processes, in the repository, may be identified by the operational process identification module 203 based on the one or more attributes 211. In an embodiment, one or more techniques, known to a person skilled in art, may be implemented for identifying the operational process 212. In an embodiment, the one or more attributes 211 may be compared with the plurality of attributes associated with each of the plurality of operational processes for identifying the operational process 212. Based on the comparison, the score for each of the plurality of operational processes may be calculated. The score may be calculated using one or more techniques known to a person skilled in art. In an embodiment, the one or more attributes 211 may be based on matching of the one or more attributes 211 with the plurality of attributes of each of the plurality of operational processes. The score for each of the plurality of operational processes may be determining based on similarity between the one or more attributes 211 and the plurality of attributes of the corresponding operational process. The score may be highest when more number of plurality of attributes of the operational process may be similar to the one or more attributes 211. The score may be least when less number of plurality of attributes of the operational process may be similar to the one or more attributes 211. In an embodiment, the score may be in form of percentage. Further, based on the score, the operational process 212 may be identified for generating the one or more test scripts 213. The score of each of the plurality of operational processes may be compared with the predefined score threshold value. The operational process 212 from the plurality of operational processes, for which the score is greater than the predefined score threshold value, may be said to be identified. In an embodiment, when two or more operational processes from the plurality of operational processes may be associated with the score greater than predefined score threshold value, then the operational process 212 from said two or more operational process may be identified based on highest value of the score. In a scenario, where no score is greater than the predefined score threshold value, then the user may input one or more new operational processes for the enterprise along with one or more new attributes and new validation data associated with the one or more new operational processes. In an embodiment, the one or more new operational processes, the one or more new attributes and the new validation data may be stored in the repository 102. In an embodiment, the user may input the one or more new operational processes, the one or more new attributes and the new validation data through one or more techniques, known to person skilled in art.

Upon identifying the operational process 212, the one or more test script 213 may be generated by the test script generation module 204 for the operational process 212 based on the metadata 216 associated with the operational process 212. In an embodiment, the one or more test scripts 213 may be generated using the unit level test scripts, the attribute data, the validation data and the condition data retrieved from the repository 102. In an embodiment, data associated with the UI 105 may also be used for generating the one or more test scripts 213. In an embodiment, the data associated with the UI 105 may be the one or more error conditions 210. In an embodiment, the one or more error conditions 210 may be used to identify possible validations from the repository 102 for generating the one or more test scripts 213. In an embodiment, the one or more error conditions 210 may also be used to build negative scenario validations for the one or more test scripts and validation for correcting the one or more error conditions 210.

The generated one or more test scripts 213 may be used directly to test the operational process 214 by using one or more techniques known to a person skilled in art.

Further, the updating module 205 updates the test script generation system 101 either manually or using the machine learning module 103. In an embodiment, at least one of the one or more new attributes and the one or more new operational processes may be updated manually by the user 105. In an embodiment, the updating of the one or more new operational processes may include, updating one or more attributes, validation rules and other data associated with the one or more new operational processes. When the one or more labels 209 may not be mapped with the plurality of attributes, the one or more new attributes, associated with the one or more labels 209, are updated using one of the machine learning module 103. In an embodiment, the machine learning module 103 may be configured to learn the plurality of patterns based on at least one of metadata in the repository and inputs from the user 105. In an embodiment, the machine learning module 103 may also be configured to automatically recognize at least one of change in the plurality of attributes and change in combination of attributes associated with each of the plurality of operational processes. In an embodiment, the machine learning module 103 may use prediction models, known to person skilled in art, to update the test script generation system 101. In an embodiment, when the one or more new attributes are identified, the machine learning module 103 may be configured to identify operational process associated with the one or more new attributes. In an embodiment, the machine learning module 103 may include attribute categorization using categorization model known to a person skilled in art. The attribute categorization may be performed to understand differentiations across customers and domains in the enterprise.

The other data 215 may store data, including temporary data and temporary files, generated by modules for performing the various functions of the test script generation system 101. The one or more modules 109 may also include other modules 206 to perform various miscellaneous functionalities of the test script generation system 101. It will be appreciated that such modules may be represented as a single module or a combination of different modules.

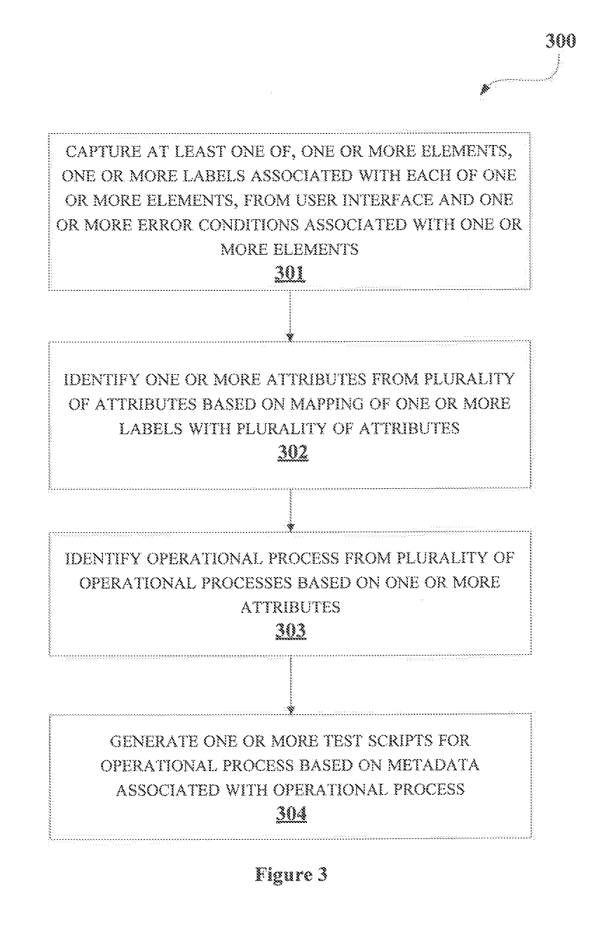

FIG. 3 illustrates a flowchart showing the method for generating the one or more test scripts 213 for testing the operational process 212 in accordance with some embodiments of present disclosure.

At block 301, the capturing module 201 captures at least one of, the one or more elements 208, the one or more labels 209 associated with each of the one or more elements 208, from the UI 105 and the one or more error conditions 210 associated with the one or more elements 208. The one or more error conditions 210 may arise when there exists error with respect to the one or more elements 208 provided by the user 106.

At block 302, the attribute identification module 202 identifies the one or more attributes 211 from plurality of attributes based on mapping of the one or more labels 209 with plurality of attributes. One or more mapping tools, known to a person skilled in art may be used to identify the one or more attributes 211.

At block 303, the operational process identification module 203 identifies the operational process 212 from the plurality of operational processes based on the one or more attributes 211. The operational process may be identified by comparing the one or more attributes with the plurality of attributes associated with each of the plurality of operational processes.

At block 304, the test script generation module 204 generates the one or more test scripts 213 for the operational process 212 based on the metadata associated with the operational process 212. The generated one or more test scripts may be further used for the operational process testing.

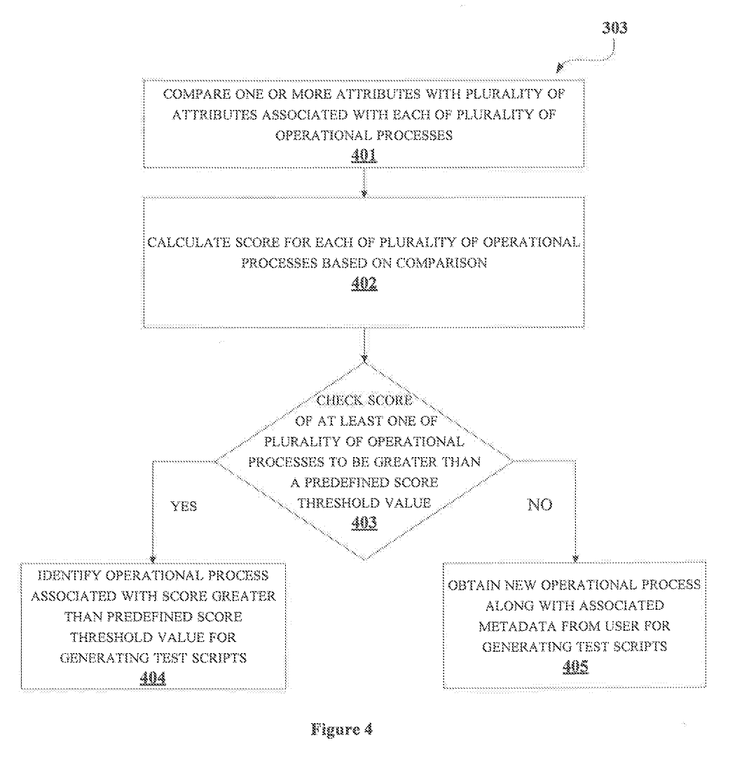

FIG. 4 illustrates a flowchart showing the method for identifying the operational process 212 to generate the one or more test scripts 213 for operational process testing in accordance with some embodiments of present disclosure.

At block 401, the operational process identification module 203 compares the one or more attributes 211, identified at block 302, with the plurality of attributes of each of the plurality of operational processes in the repository 102.

At block 402, the operational process identification module 203 calculates the score for each of plurality of operational processes based on the comparison performed at block 401.

At block 403, the operational process identification module 203 checks the score of at least one of the plurality of operational processes to be greater than the predefined score threshold value. When the score of at least one of the plurality of operational processes is greater than the predefined score threshold value, step in block 404 may be performed. When the score of at least one of the plurality of the operational processes is not greater than predefined the predefined score threshold value, step in block 405 may be performed.

At block 404, when the score of the operational process is greater than the predefined score threshold value at block 403, the operational process identification module 203 identifies the operational process associated with score greater than the predefined score threshold value for generating the one or more test scripts 213.

At block 405 when the score of at least one of the plurality of the operational processes is not greater than predefined the predefined score threshold value at block 403, the operational process identification module 203 obtains one or more new operational processes along with associated metadata from the user 106 for generating the one or more test scripts 213.

In an embodiment, when two or more operational processes from the plurality of operational processes may be associated with the score greater than predefined score threshold value, then operational processes from said two or more operational process may be identified based on highest value of the score.

As illustrated in FIGS. 3 and 4, the methods 300 and 303 may include one or more blocks for executing processes in the test script generation system 101. The methods 300 and 303 may be described in the general context of computer executable instructions. Generally, computer executable instructions can include routines, programs, objects, components, data structures, procedures, modules, and functions, which perform particular functions or implement particular abstract data types.

The order in which the methods 300 and 303 are described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

### Computing System

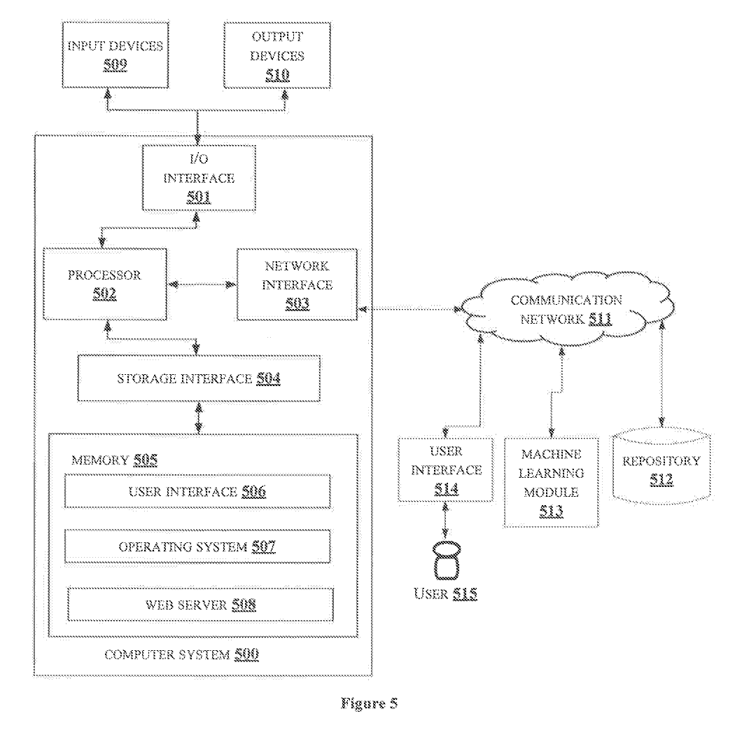

FIG. 5 illustrates a block diagram of an exemplary computer system 500 for implementing embodiments consistent with the present disclosure. In an embodiment, the computer system 500 is used to implement the decision-monitoring device 101. The computer system 500 may include a central processing unit (“CPU” or “processor”) 502. The processor 502 may include at least one data processor for executing processes in Virtual Storage Area Network. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices 509 and 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 consists of a test script generation system 101. The processor 502 may be disposed in communication with the communication network 511 via a network interface 503. The network interface 503 may communicate with the communication network 511. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 511 may include, without limitation, a direct interconnection, local area network (LAN), wide area network (WAN), wireless network (e.g., using Wireless Application Protocol), the Internet, etc. Using the network interface 503 and the communication network 511, the computer system 500 may communicate with a user 515 via UI 514, machine learning module 513 and a repository 512 for generating test script for operational process testing. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/g/n/x, etc.

The communication network 511 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure allows automatic identification of operational process resulting in faster writing of automated regression test scripts.

An embodiment of the present disclosure reduces time and effort to generate test scripts.

An embodiment of the present disclosure provides flexibility to configure test scripts for any small differentiations for a customer and domain.

An embodiment of the present disclosure learns and updates repository by using machine learning models thereby updates overall system for generating test scripts.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3 and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Test script generation system |
| 102 | Repository |
| 103 | Machine learning module |
| 104 | Communication network |
| 105 | User interface |
| 106 | User |
| 107 | Processor |
| 108 | I/O network |
| 109 | Modules |
| 110 | Memory |
| 201 | Capturing module |
| 202 | Attribute identification module |
| 203 | Test script generation module |
| 204 | Operational process identification module |
| 205 | Updating module |
| 206 | Other modules |
| 207 | Data |
| 208 | Element data |
| 209 | Label data |
| 210 | Error condition data |
| 211 | Attribute data |
| 212 | Operational process data |
| 213 | Test script data |
| 214 | Metadata |
| 215 | Other data |
| 400 | Computer System |
| 501 | I/O Interface |
| 502 | Processor |
| 503 | Network Interface |
| 504 | Storage Interface |
| 505 | Memory |
| 506 | User Interface |
| 507 | Operating System |
| 508 | Web Server |
| 509 | Input Devices |
| 510 | Output Devices |
| 511 | Communication Network |
| 512 | Expert user |
| 513 | Data source |

We claim:

1. A method for generating test scripts for operational process testing, comprising:
capturing, by a test script generation system (101), at least one of, one or more elements (208), one or more labels (209) associated with each of the one or more elements (208), from a user interface (105) and one or more error conditions (210) associated with the one or more elements (208);
identifying, by the test script generation system (101), one or more attributes (211) from a plurality of attributes based on mapping of the one or more labels (209) with the plurality of attributes;
identifying, by the test script generation system (101), an operational process (212) from a plurality of operational processes based on the one or more attributes (211); and
generating, by the test script generation system (101), one or more test scripts (213) for the operational process (212) based on metadata (214) associated with the operational process (212).

2. The method as claimed in claim 1 further comprising updating, by the test script generation system (101), at least one of one or more new attributes, one or more new operational processes and the metadata (214), when one of the one or more attributes (211) and the operational process (212) is not identified.

3. The method as claimed in claim 2, wherein the one or more new attributes are updated, using a machine learning module associated with the test script generation system (101), based on plurality of patterns associated with the plurality of operational processes and corresponding plurality of attributes.

4. The method as claimed in claim 1, wherein the mapping of the one or more labels (209) with the plurality of attributes comprises mapping synonyms of the one labels with the plurality of attributes.

5. The method as claimed in claim 1, wherein the metadata (214) comprises at least one of enterprise data, business domain data, operational process data, attributes data, validation data associated with the plurality of attributes, condition data associated with the plurality of validation data and unit level test scripts.

6. The method as claimed in claim 1, wherein identification of the operational process (212) comprises:
comparing the one or more attributes (211) with the plurality of attributes associated with each of the plurality of operational processes;
calculating a score for each of the plurality of operational processes based on the comparison; and
identifying the operational process (212) based on at least one of the score and a predefined score threshold value.

7. A test script generation system (101) for generating test scripts for operational process testing, comprises:
a processor; and
a memory communicatively coupled to the processor, wherein the memory stores processor-executable instructions, which, on execution, cause the processor to:
capture at least one of, one or more elements (208), one or more labels (209) associated with each of the one or more elements (208), from a user interface (105) and one or more error conditions (210) associated with the one or more elements (208);
identify one or more attributes (211) from a plurality of attributes based on mapping of the one or more labels (209) with the plurality of attributes;
identify an operational process (212) from a plurality of operational processes based on the one or more attributes (211); and
generate one or more test scripts (213) for the operational process (212) based on metadata (214) associated with the operational process (212).

8. The test script generation system (101) as claimed in claim 7 further comprises the processor to update at least one of one or more new attributes, one or more new operational processes and the metadata (214), when one of the one or more attributes (211) and the operational process (212) is not identified.

9. The test script generation system (101) as claimed in claim 8, wherein the one or more new attributes are updated using a machine learning module associated with the test script generation system (101) based on plurality of patterns associated with the plurality of operational processes and corresponding plurality of attributes.

10. The test script generation system (101) as claimed in claim 7, wherein the mapping of the one or more labels (209) with the plurality of attributes comprises mapping synonyms of the one labels with the plurality of attributes.

11. The test script generation system (101) as claimed in claim 7, wherein the metadata (214) comprises at least one of enterprise data, business domain data, operational process data, attributes data, validation data associated with the plurality of attributes, condition data associated with the plurality of validation data and unit level test scripts.

12. The test script generation system (101) as claimed in claim 7, wherein identification of the operational process (212) comprises:
comparing the one or more attributes (211) with the plurality of attributes associated with each of the plurality of operational processes;
calculating a score for each of the plurality of operational processes based on the comparison; and
identifying the operational process (212) based on at least one of the score and a predefined score threshold value.

13. A non-transitory computer readable medium including instructions stored thereon that when processed by at least one processor cause a device to perform operations comprising:
capturing at least one of, one or more elements (208), one or more labels (209) associated with each of the one or more elements (208), from a user interface (105) and one or more error conditions (210) associated with the one or more elements (208);
identifying one or more attributes (211) from a plurality of attributes based on mapping of the one or more labels (209) with the plurality of attributes;
identifying an operational process (212) from a plurality of operational processes based on the one or more attributes (211); and
generating one or more test scripts (213) for the operational process (212) based on metadata (214) associated with the operational process (212).

14. The medium as claimed in claim 13 further comprising updating at least one of one or more new attributes, one or more new operational processes and the metadata (214), when one of the one or more attributes (211) and the operational process (212) is not identified.

15. The medium as claimed in claim 14, wherein the one or more new attributes are updated, using a machine learning module associated with the test script generation system (101), based on plurality of patterns associated with the plurality of operational processes and corresponding plurality of attributes.

16. The medium as claimed in claim 13, wherein the mapping of the one or more labels (209) with the plurality of attributes comprises mapping synonyms of the one labels with the plurality of attributes.

17. The medium as claimed in claim 13, wherein the metadata (214) comprises at least one of enterprise data, business domain data, operational process data, attributes data, validation data associated with the plurality of attributes, condition data associated with the plurality of validation data and unit level test scripts.

18. The medium as claimed in claim 13, wherein identification of the operational process (212) comprises:
comparing the one or more attributes (211) with the plurality of attributes associated with each of the plurality of operational processes;
calculating a score for each of the plurality of operational processes based on the comparison; and
identifying the operational process (212) based on at least one of the score and a predefined score threshold value.
